(19) United States
(12) Patent Application Publication
(10) Pub. No.: US 2013/0340633 A1
(43) Pub. Date: Dec. 26, 2013

(54) JUICE EXTRACTOR WITH BRAKE PROTECTION DEVICE

(71) Applicant: PEI-HSING WU, TAOYUAN COUNTY (TW)

(72) Inventor: PEI-HSING WU, TAOYUAN COUNTY (TW)

(21) Appl. No.: 14/010,706

(22) Filed: Aug. 27, 2013

Related U.S. Application Data
(63) Continuation-in-part of application No. 13/015,742, filed on Jan. 28, 2011.

(51) Int. Cl. A23N 1/02

(52) U.S. Cl. CPC A23N 1/02
USPC 99/509

(57) ABSTRACT

A juice extractor with a brake protection device comprises a main body including a power cutting device and a brake protection device received therein. The power cutting device includes a motor with a driving shaft, and a blade disc is connected to the driving shaft. The brake protection device includes an operation member movably and pivotably connected to the main body, at least a spring connected to the main body, at least a brake frame pivotably connected to the main body, a micro-switch disposed inside the main body, and a brake disc connected to the driving shaft. The operation member has a push member which is coupled to the brake frame and the spring. When the operation member is moved downward and detached from a stopping portion disposed at a top portion of the main body, the push member is pressed downward to push the micro-switch in order to cut off the power for a motor. The push member releases a force applied to the brake frame and the spring, so that the brake frame applies a force to the brake disc to brake the motor for protection. When the operation member is moved upward and stopped by the stopping portion disposed at the top portion of the main body, the push member rises and releases the brake frame and the spring; the micro-switch is detached in order that the brake frame releases the brake disc.

### REFERENCE TO RELATED APPLICATION

This Application is being filed as a Continuation-in-Part Application of patent application Ser. No. 13/015,742, filed 28 Jan. 2011, currently pending.

### BACKGROUND OF THE INVENTION

1. Field of Invention

The present invention relates to a juice extractor and more particularly to a juice extractor with a brake protection device which can provide safety and protection when the juice extractor is operated.

2. Related Art

Conventional juice extractors for extracting juice from fruits and vegetables are equipped with a blade disc turned by a motor, and a common power switch structure. A motor and a blade disc driven and turned by the motor are disposed in a lower base of a main body of the juice extractor. A feed opening is disposed on a top cover of the main body. The top cover and the lower base of the main body are coupled and fixed together by a U-shaped frame.

If the U-shaped frame is detached from the top cover or the lower base of the main body when the power for the juice extractor is turned on and the blade disc is driven and turned by the motor, the blade disc driven and turned by the motor is exposed to cause danger. Even if the power for the juice extractor is turned off immediately, it is still dangerous because the motor and the blade disc are still in motion due to the inertia force.

### SUMMARY OF THE INVENTION

A main objective of the present invention is to provide a juice extractor with a brake protection device by which a motor and a blade disc can be stopped from turning anytime in order to provide safety and protection for the juice extractor for extracting juice from fruits and vegetables.

A secondary objective of the present invention is to provide an operation member with a U-shaped frame for coupling and securing a top cover and a lower base of a main body of the juice extractor. The operation member is coupled with a brake device. When the operation member is detached from the securing between the top cover and the lower base, the brake device can provide braking and protective functions.

The main body of the juice extractor includes a power cutting device and a brake protection device received therein. The power cutting device includes a motor with a driving shaft, and a blade disc is connected to the driving shaft.

The brake protection device includes an operation member movably and pivotably connected to the main body, at least a spring connected to the main body, at least a brake frame pivotably connected to the main body, a micro-switch disposed inside the main body, and a brake disc connected to the driving shaft. The operation member has a push member which is coupled to the brake frame and the spring. When the operation member is moved downward and detached from a stopping portion disposed at a top portion of the main body, the push member is pressed downward to push the micro-switch in order to cut off the power for the motor. The push member releases a force applied to the brake frame and the spring, so that the brake frame applies a force to the brake disc to brake the motor and the blade disc from turning for protection. When the operation member is moved upward and stopped by the stopping portion disposed at the top portion of the main body, the push member rises and releases the brake frame and the spring; the micro-switch is pressed and pushed in order that the brake frame releases the brake disc.

Preferably, the brake frame has at least one type of torsion spring which stores elasticity when the brake frame releases a force applied to the brake disc. When the brake frame releases the brake disc, the torsion spring drives the brake frame to an original position by the stored elasticity.

The stopping portion is a groove with an inclined plane provided for a guide member of the operation member to slide into the groove.

The operation member is a U-shaped link. The guide member is a roller.

The brake frame in contact with the brake disc has a part with high friction coefficient. The part with high friction coefficient has excellent frictional and braking effects. The part with high friction coefficient is made of rubber, plastic, or other composite materials for reducing the noise caused by the braking action.

The present invention will become more fully understood by reference to the following detailed description thereof when read in conjunction with the attached drawings.

### BRIEF DESCRIPTION OF THE DRAWINGS

FIG. 1 is a top view of a juice extractor according to the present invention;

FIG. 2 is a cross sectional view taken along line 2-2 in FIG. 1;

FIG. 3 is a cross sectional view of the juice extractor under the non-braking status;

FIG. 4 is a cross sectional view taken along line 1-1 in FIG. 1; and

FIG. 5 is a cross sectional view of the juice extractor under the braking status.

### DETAILED DESCRIPTION OF THE INVENTION

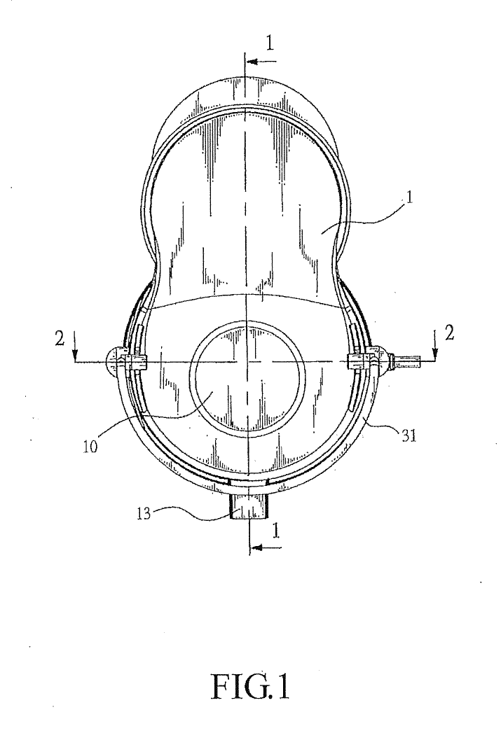

Please refer to FIGS. 1 to 3, which show a juice extractor with a brake protection device in accordance with the present invention. The juice extractor comprises a main body 1 in which a power cutting device 2 and a brake protection device 3 are located. The power cutting device 2 has a motor 21 with a driving shaft 211. The motor 21 is disposed in an upright position and the driving shaft 211 extends upwardly and vertically. A brake disc 37 is connected to the driving shaft 211. A blade disc 22 disposed horizontally is connected to an upper end of the driving shaft 211. A vertically disposed feed passage 10 is located in a top portion of the main body 1 and located corresponding to the blade disc 22. After the fruits or vegetables are put into the feed passage 10, a pusher 11 which can be moved axially, is used to push the fruits or vegetables in the feed passage 10 toward the blade disc 22 so that the fruits or vegetables are cut by the blade disc 22 and the juice is discharged from an outlet 13.

The brake protection device 3 includes an operation member 31 movably and pivotably connected to the main body 1, at least a spring 34 connected to the main body 1, at least a brake frame 35 pivotably connected to the main body 1, a micro-switch 38 disposed inside the main body 1, and a brake disc 35 connected to the driving shaft 211. Preferably, the operation member 31 is a U-shaped link. A guide member 33 for engaging and positioning with a stopping portion 12 disposed at a top portion of the main body 1 is disposed at a middle portion of the operation member 31. Preferably, the guide member 33 is a roller; the stopping portion 12 is a groove with an inclined plane 121 provided for the guide member 33 of the operation member 31 to slide into the groove-like the stopping portion 12. Thereby, the operation member 31 can be engaged and positioned with, or detached from the stopping portion 12. Two push members 32 are connected to two lower ends of the operation member 31 respectively. The two push members 32 enter into the main body 1 through a slot 14 and are rotatable and vertically movable in the slot 14.

An upper end of the spring 34 disposed inside the main body 1 is fixed, and a lower end of the spring 34 is in contact with the push member 32. The spring 34 is pressed or released when the push member 32 is lifted or descended vertically.

The micro-switch 38 disposed below the push member 32 and inside the main body 1 is pressed or released when the push member 32 is actuated by the operation member 31 to move downward or upward vertically in the slot 14. The pressing or releasing of the micro-switch 38 causes the power circuit of the motor 21 to be disconnected or connected.

The brake frame 35 and a torsion spring 36 are pivotably connected to the main body 1 by a pivot 351. Two ends of the torsion spring 36 are pressed against an inner side of the main body 1 and the brake frame 35 respectively. A lower end of the brake frame 35 is in contact and actuated with the push members 32. An upper end of the brake frame 35 is in contact with a brake surface 371 disposed on a bottom of the brake disc 37. A part 352 with high friction coefficient disposed at the upper end of the brake frame 35 is, for examples, made of rubber, plastic or other composite materials for reducing the noise caused by the braking action. The annular brake surface 371 disposed on the bottom of the brake disc 37 is located corresponding to the upper end of the brake frame 35.

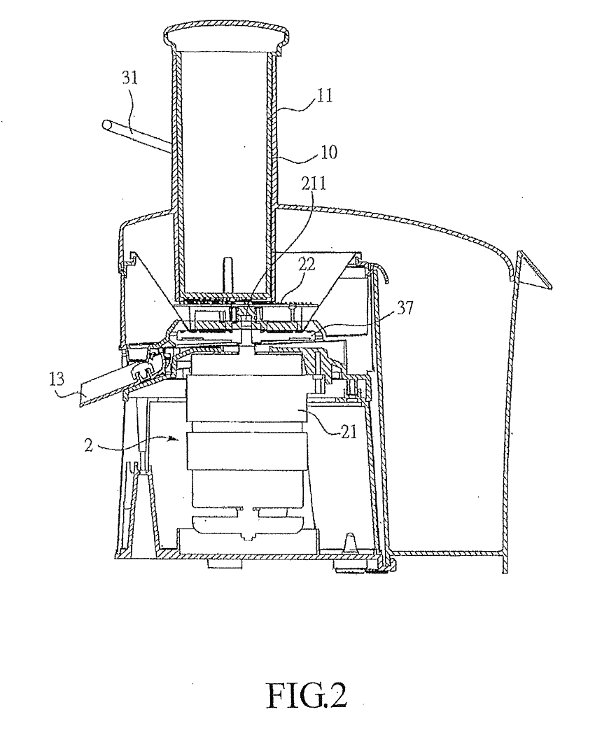

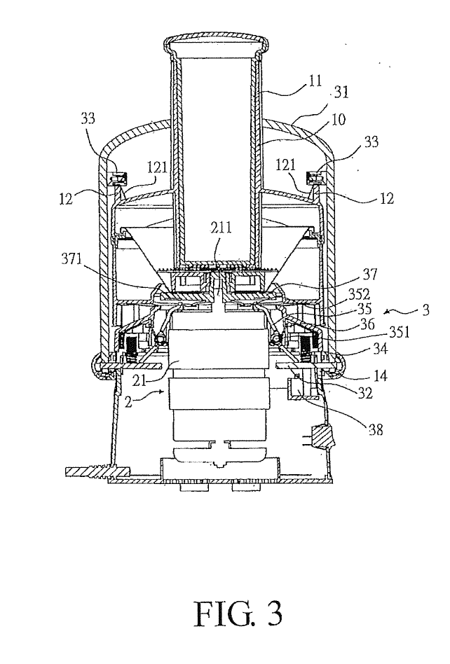

FIGS. 2 and 3 show that when using the juice extractor, the brake protection device 3 is released from the braking status so that the motor 21 and the brake disc 37 are in operation. The operation member 31 is rotated about the push members 32 and toward the upper end of the main body 1, in order to guide the guide member 33 of the operation member 31 along the inclined surface 121 and to slide in the groove-like stopping portion 12. Thereby, the operation member 31 is lifted in order to be engaged and positioned with the stopping portion 12. At the same time, the push members 32 are moved upward to press against the spring 34. The operation member 31 and the push members 32 are moved upward together in order to actuate the brake frame 35 to pivot anticlockwise to an angle about the pivot 351, and to allow the part 352 with high friction coefficient disposed at the upper end of the brake frame 35 to be separated downwardly from the brake surface 371. At the same time, the torsion spring 36 is deformed to store elasticity; the micro-switch 38 below the push member 32 is released from being pressed by the push member 32, and the circuit power of the motor 21 is connected.

The juice extractor is under an operating status when the operation member 31 is engaged and positioned with the stopping portion 12.

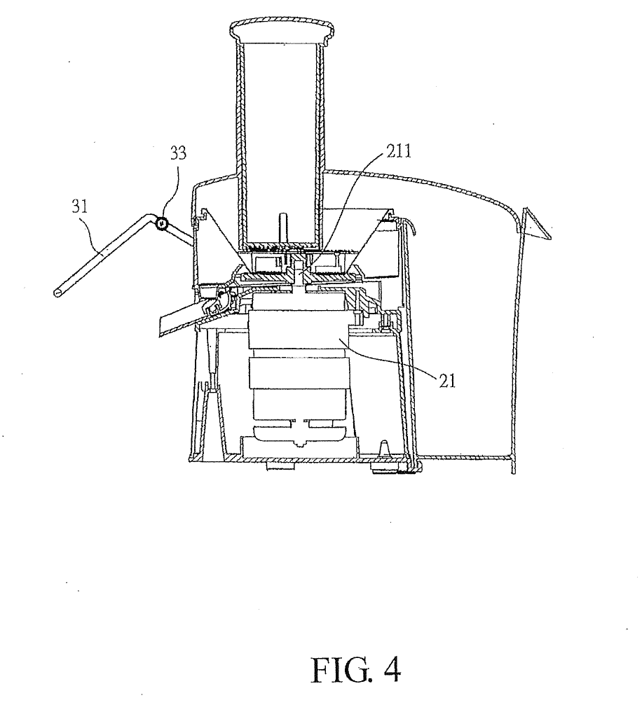

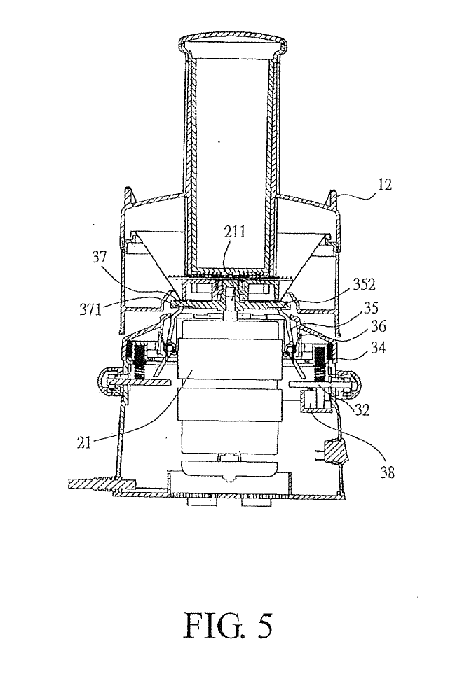

FIGS. 4 and 5 show that when using the juice extractor, the brake protection device 3 is under the braking status so that the motor 21 and the brake disc 37 are applied with braking. The operation member 31 is rotated about the push members 32 and toward the lower end of the main body 1, in order to guide the guide member 33 of the operation member 31 to detach from the groove-like stopping portion 12 along the inclined surface 121. Thereby, the operation member 31 is disengaged with the stopping portion 12. At the same time, the push members 32 are moved downward to release the spring 34 from compression and cause the spring 34 to press against the push member 32. The micro-switch 38 below the push member 32 is pressed against by the push member 32, and the circuit power of the motor 21 is disconnected. The operation member 31 and the push members 32 are moved downward together in order to actuate the brake frame 35 to pivot clockwise to an angle about the pivot 351, and the elasticity of the torsion spring 36 is released to cause the part 352 with high friction coefficient disposed at the upper end of the brake frame 35 to press against the brake surface 371 upwardly, Thereby, the brake disc 37 is applied with braking, the motor 21 and the blade disc 22 are applied with braking to stop operate in order to achieve the brake protection.

The status of the operation member 31 being disengaged with the stopping portion 12 causes the brake disc 37 to be applied with braking, the motor 21 and the blade disc 22 are also applied with braking to stop operate in order to achieve the brake protection. The brake protection is applicable when the juice extractor has not yet started to operate; even if the main power of the juice extractor is turned on, the juice extractor is protected by the brake protection device 3 and cannot be started to operate.

The brake protection device 3 of the present invention is also applicable when the juice extractor is under operation. When the operation member 31 is disengaged with the stopping portion 12 because of accidents or any abnormal operations, the brake protection can be achieved by using the micro-switch 38 to disconnect the circuit power of the motor 21 and stop the operations of the motor 21 and the blade disc 22 by the brake disc 37.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A juice extractor with a brake protection device comprising a main body, a power cutting device and a motor of the power cutting device disposed in the main body, characterized in that:
the motor is disposed inside the main body and mechanically connected to the power cutting device;
at least one stopping portion is disposed at an upper portion of the main body, the stopping portion is a groove with an inclined surface;
a brake protection device is disposed inside the main body, the brake protection device comprises an operation member movably and pivotably connected inside the main body, at least one spring connected to the main body, at least one brake frame pivotably connected to the main body, a micro-switch disposed inside the main body, and a brake disc connected to a motor driving shaft, the operation member is a U-shaped link, the operation member has at least one guide member, push members are disposed below the operation member, the spring is actuated by the push member to stretch or contract elastically, the micro-switch is actuated by the push member to disconnect or connect a circuit power of the motor, the brake frame is actuated by the push member to brake or release the brake disc, the guide member is detached from or engaged with the stopping portion of the main body by operating the operation member of the brake protection device, and the push member is actuated to actuate the micro-switch to disconnect or connect the circuit power of the motor, and to actuate the brake frame to brake or release the brake disc.

2. The juice extractor with the brake protection device as claimed in claim 1, characterized in that, the brake frame has at least one torsion spring.

3. The juice extractor with the brake protection device as claimed in claim 1, characterized in that, the guide members are disposed at two symmetrical sides of the U-shaped link.

4. The juice extractor with the brake protection device as claimed in claim 1, characterized in that, the brake disc has a brake surface for contacting with the brake frame.

5. The juice extractor with the brake protection device as claimed in claim 4, characterized in that, the brake frame has a part with high friction coefficient for contacting with the brake surface.

6. The juice extractor with the brake protection device as claimed in claim 5, characterized in that, the part with high friction coefficient is made of rubber.

7. The juice extractor with the brake protection device as claimed in claim 1, characterized in that, the guide member is a roller.
